(19) United States
(12) Patent Application Publication
(10) Pub. No.: US 2026/0195993 A1
(43) Pub. Date: Jul. 9, 2026

(54) METHOD FOR TRIGGERING ACTIONS IN THE METAVERSE OR VIRTUAL WORLDS

(71) Applicant: VIEWPOINTSYSTEM GMBH, Wien (AT)

(72) Inventors: Eddy VINDIGNI, Vienna (AT); Primoz FLANDER, Wien (AT); Frank LINSENMAIER, Weinstadt (DE); Nils BERGER, Schaan (LI)

(73) Assignee: VIEWPOINTSYSTEM GMBH, Wien (AT)

(21) Appl. No.: 19/132,130

(22) PCT Filed: Nov. 24, 2022
(86) PCT No.: PCT/IB2022/061369

§ 371 Date: May 22, 2025

(51) Int. Cl. G06T 19/00; G06F 3/01; G06T 15/10

(52) U.S. Cl. CPC G06T 19/00; G06F 3/013; G06T 15/10; G06T 2219/024

(57) ABSTRACT

A method for giving consent to trigger an action and/or a status change when interaction is established between avatars in the Metaverse or a virtual/mixed/extended reality world. The trigger is given when eye contact is established between the avatars, representing the intention to interact and/or not to interact of their corresponding users.

### CROSS-REFERENCE TO RELATED APPLICATIONS

The present application is a national phase application of PCT Application No. PCT/IB2022/061369, filed Nov. 24, 2022, entitled “METHOD FOR TRIGGERING ACTIONS IN THE METAVERSE OR VIRTUAL WORLDS”, which is incorporated by reference in its entirety.

### BACKGROUND OF THE INVENTION

### 1. Field of the Invention

The present invention discloses a method for triggering actions in the Metaverse or in virtual worlds.

### 2. Description of the Related Art

The term “virtual worlds” as used herein means virtual/mixed/extended reality worlds, therefore worlds that are accessible by a virtual/mixed/extended reality headset, which provide the user with a computer-generated Virtual Reality with which the user may interact. The user, by his/her Avatar, enters this virtual world and can control things or conduct a sequence of actions.

In order to enable more immersive and realistic participation in the Virtual World, the user—as anticipated—may use an HMD (Head-mounted display), which is able to show an image through the display and play sounds through the speaker integrated into the device.

An HMD may be further provided with an eye-tracking module, as auxiliary input means. This module tracks eye movement when the user moves his/her eyes without turning his/her head. It is a technology that allows the user to see what kind of object the user is paying attention to.

The Metaverse is an integrated network of 3D virtual worlds, namely computing environments, providing immersive experiences to users.

Generally, the Metaverse may be accessed by users through a Virtual Reality headset—users navigate the Metaverse using their eye movements, feedback controllers or voice commands, but this is not strictly necessary.

The scientific paper “A Metaverse: Taxonomy, Components, Applications, and Open Challenges” (Sang-Min Park et al.) (1) published in January 2022 describes the Metaverse concepts, architecture and contents, providing a comprehensive analysis of the current status of the technology and the direction for implementing the immersive Metaverse and open challenges.

First of all, it is important to highlight that “The Metaverse differs from augmented reality (AR) and Virtual Reality (VR) in three ways. First, while VR-related studies focus on a physical approach and rendering, Metaverse has a strong aspect as a service with more sustainable content and social meaning. Second, the Metaverse does not necessarily use AR and VR technologies. Even if the platform does not support VR and AR, it can be a Metaverse application. Lastly, the Metaverse has a scalable environment that can accommodate many people is essential to reinforce social meaning.” (1).

Therefore a Metaverse application may be accessed by a user through a normal personal computer without any specific head-mounted device, like a VR headset.

Also known are gaze-tracking devices, which may have the form of spectacles, which may be also used to access the Metaverse world displayed on the screen of a normal PC. They usually comprise a sensor, which is oriented onto an eye of the spectacles wearer; providing data of the eye which in turn are computed in order to give as output the coordinates of the pupil and the viewing direction of the eye. Such viewing direction can be displayed on a correspondent display computer device where a second user is able to appreciate the gaze direction of the wearer on his/her relevant field of view, via Internet live streaming. Therefore together with a so-called field of view video, which is prepared by a further field of view camera arranged on the spectacles in the viewing direction of a user, the point at which the user looks can be ascertained using such spectacles and streamed via the Internet to a second user remotely connected to the gaze tracking device.

Typically, the user interacts with the Metaverse world through his/her avatar. An avatar is the user's alter ego and becomes the active subject in the Metaverse world. An avatar is a computer anthropomorphic representation of a user that typically takes the form of a three-dimensional (3D) model. Said avatars may be defined by the user in order to represent the user's actions and aspects of their persona, beliefs, interests, or social status.

The computing environments implementing the Metaverse World allow creation of an avatar and also allow customizing the character's appearance. For example, the user may customize the avatar by adding hairstyle, skin tone, body build, etc. An avatar may also be provided with clothing, accessories, emotes, animations, and the like.

From what is known so far, Virtual Reality has restrictions and deals only with having a virtual journey, seeming to be all about simulations and having fun with virtual worlds. Smita. verma (4) adds The Metaverse, on the other hand, has no set boundaries since it is a product of multiple types of technology such as Augmented and Virtual Reality and more. In the Metaverse, users may also be able to purchase or develop digital objects as well as places or NFTs. While Virtual Reality is usually confined to a certain number of people, including a game's player size restriction, the Metaverse is considered an open virtual environment where users may all travel, enjoy, and communicate with everyone at no expense throughout the whole Internet. It will be a shared digital space that consumers will be able to experience via the world wide web. The Metaverse is continually moving and blending real and virtual experiences using things like Augmented Reality and other technologies, giving the user a true, real-life sense in a virtual style that is always available and has real-life results in multiple formats. (4). On the contrary, Virtual Reality works discontinuously, only for that particular experience the user wants to live and when the headset is turned off, that world does not develop per se, it remains static.

M. Kaur et al. (2) describes Metaverse as “Metaverse technology is being called the next big revolution of the Internet. The Metaverse is a virtual environment where users may create avatars to duplicate their real-world or physical-world experiences on a virtual platform . . . . By 2028, the Metaverse market is estimated to be worth USD 814.2 billion, with a CAGR of 43.8 percent during the forecast period. The worldwide Metaverse business is increasing because of rising interest in areas such as socializing, entertainment, and creativity.”.

J. Goldston et al. (3) mentioned and describe Omniverse from Nvidia “While some Metaverses will be built for community gatherings and gaming, others will be built for scientists, creators, and companies. One of the drivers of innovation in the Metaverse will be the creator economy. Developers and creators will have an array of tools at their disposal that will enable them to bring innovative products to market in an unprecedented fashion. Indeed, it is very likely that creators will make more tools in virtual worlds than they do in the physical world. One of the AI programs designed for builders of these virtual worlds is Nvidia's Omniverse. The omniverse allows artists and developers to collaborate, test, design, and visualize projects from remote locations in real-time by providing a user-friendly server backend that enables users to access an inventory of 3D assets in a Universal Scene Description (USD) format. Assets from this inventory can be utilized in a number of ways as Nvidia's Omniverse provides plugins for 3D digital content creations (DCC) as well as tools that assist artists such as PhysX 5.0, RTX based real-time render engine, and a built-in Python interpreter and extension system (Jon Peddie Research, 2021). Ultimately, as every omniverse tool is built as a plugin, artists and developers can easily customize products for their specific use cases.

One of the use cases of omniverse includes Bayerische Motoren Werke 25 AG (BMW), a German multinational corporate manufacturer of luxury vehicles. Currently, BMW produces one new vehicle every minute. To keep up with their demand for continuous improvement and innovation, BMW requires the simulation of complex production scenarios to speed up output, increase agility, and optimize efficiency.

In addition, currently are known Metaverse Game like ROBLOX which Sang-Min Park et al. (1) describes ROBLOX as “Roblox served by two-thirds of 9-12 years old in the United States and is a representative game of Metaverse with an MAU of 150 million [1]. Roblox is also used to develop simulations of urban environments to describe experiences that incorporate the realization of virtual paths to the city's sculptural heritage in the classroom Although norms between education and entertainment have often been regarded as two separate worlds, Roblox is used as an educational tool in the classroom from the perspectives of motivation, problem-solving, and STEM”.

DECENTRALAND is a Metaverse world designed around the cryptocurrency MANA, used to trade items and virtual real estate properties. This virtual game platform runs on the Ethereum blockchain.

Other Metaverse worlds are currently existing and others will be developed in the future, but they, in any case, have in common interaction between avatars, generally, anthropomorphic avatars, representing the “alter ego” of real users in the virtual world. Unfortunately there are already reported cases of misbehaviors between users acting via their avatars in the Metaverse. On 16 Dec. 2021 the “MIT Technology Review” published an article with the title “The Metaverse has a groping problem already”, where it was declared that “According to Meta, on November 26, a beta tester reported something deeply troubling: she had been groped by a stranger on Horizon Worlds”. On December 1, Meta revealed that she′d posted her experience in the Horizon Worlds beta testing group on Facebook.

Furthermore, on Mar. 2, 2022 USA TODAY TECH published another article titled “Sexual harassment in the Metaverse? Woman alleges rape in virtual world “describing that “Within 60 seconds of joining,” she wrote in the post from December, “I was verbally and sexually harassed—3-4 male avatars, with male voices, essentially, but virtually gang raped my avatar.’”

On 15 Mar. 2022 Meta announces in response to the incidents, added a “personal boundary” to its Metaverse platform which creates an invisible boundary that can prevent users from coming within four feet of other avatars. The user is allowed to set this boundary from three options that give the community a sort of customized controls so they can decide how they want to interact in their VR experiences, but in any case, there is no possibility to remove the invisible physical boundary to prevent unwanted interactions.

This restricts in any case any possible strict interaction between avatars and it's not replicating what happens in the real world, where nobody has a physical boundary around his/her body.

Furthermore, EP3491781 described a method of being able to activate a chat with an avatar when the user, using his/her head-mounted device, is looking at that avatar, but it does not mention how to solve the problem that the user of the avatar may prevent this action.

WO2021/202783 addresses the specific task of how to scale an avatar in the physical world of the user, i.e. how one-to-one mapping works in the Augmented Reality technology between user and avatar. It focuses, in particular, on automatically scaling the avatar dimension in a way that increases and maximises the direct eye contact, based on the height level of the user's eyes, minimizing possible neck strain for the users (see FIG. 11A and paragraphs 153, 170). This document does not deal with and mentions any social interaction between Avatars in the Metaverse world or in any Virtual world.

The Metaverse is still affected by safety problems because there is no possibility to block unwanted interaction. The only possibility was provided by Meta implementing a physical boundary which is perceived as an artificial mean, completely unrealistic, limiting all possible interaction among users acting by their avatars in the Metaverse world.

### SUMMARY OF THE INVENTION

One objective of the present invention, according to a first of its aspects, is obtaining a method for giving consent for triggering action and/or status change on an avatar when it is interacting with other avatars in a virtual world, without using a manual tool/device like a mouse or hand tool, controller, making them fictitious.

A second objective of the present invention is providing a reliable method for establishing safe and conscious bidirectionally approved interactions between avatars, having concurrently the consent of both avatars representing the correspondent users.

A third objective of the present invention is providing a method of preventing undesired and unwanted interactions between users, maintaining at the same time realistic and spontaneous interactions, without the necessity to adopt physical boundaries.

A fourth objective of the present invention is further providing a discriminate between the level of interaction between two avatars, for example, simple staring or willingness to interact or even more avoid to interact.

A fifth objective of the present invention is providing a method usable by people having diseases affecting their arms and/or hands.

A further objective of the present invention is providing a method consenting realistic interactions between avatar users, securer if compared to known methods.

Another objective of the present invention is providing a method able to solve all mentioned prior art drawbacks disclosed in the present specification.

Hereinafter are summarized some technical aspects of the present inventions which enable some of the most important purposes to be achieved.

According to a first aspect, this invention relates to a method for triggering status change and/or specific action between two avatars acting in the Metaverse or in a virtual world, said virtual world which may be a virtual/mixed/extended reality world. After having mapped the two gaze vectors of two avatars in the Metaverse or Virtual world, the method detects if eye contact between the two avatars is established and, if yes, this condition triggers further action, such as allowing social interaction between the two.

Such a method confers the possibility to avoid problems related to unwanted interaction, the safety condition of avatars in the Metaverse, and the need to implement physical boundaries, which may turn the virtual environment unrealistic.

According to a second aspect, this invention relates to a method wherein established a social interaction time, further conditioning the possibility to trigger further social interaction. Such a feature avoids that staring might be exchanged as eye contact. According to a third aspect, this invention relates to a method wherein is established a glance avoidance time, is further conditioning the possibility to trigger further social interaction. This feature prevents unwanted social interaction with ill-intentioned avatars. According to further aspects, this invention relates to further method features claimed in the dependent claims of the present specification.

### BRIEF DESCRIPTION OF THE DRAWINGS

The structural and functional features of the present invention and its advantages with respect to the known prior art, will become even clearer from the underlying claims, and in particular, by an examination of the following description, made with reference to the attached figures which show a preferred but not limited schematic embodiment of the invented method, system, device, in which:

FIGS. 1A and 1B illustrate a first preferred embodiment of the system architecture according to the present invention;

FIG. 2a, 2b illustrate flow charts of the method according to the first preferred embodiment under the present invention and its variants;

FIGS. 3A and 3B illustrate a second preferred embodiment of the system architecture according to the present invention;

FIG. 4a, 4b illustrate flow charts of the method according to the second preferred embodiment under the present invention and its variants;

FIG. 5 illustrates the functioning of the method according to the present invention in the virtual world.

FIG. 6a, 6b, 6c, 6d illustrate possible regions of interest according to the method of the present invention.

FIG. 7, 8 illustrate schematic representations of eye glance behavior 15 with a sequence for initial fixation, a saccade and a second fixation.

FIG. 9a, 9b illustrate flow charts of further preferred embodiments of the method according to the present invention.

### DETAILED DESCRIPTION

This disclosure describes a method for triggering status change and/or specific action between two avatars acting in the Metaverse or in a virtual world, said virtual world which may be a virtual/mixed/extended reality world.

The Metaverse or these virtual worlds (namely virtual/mixed/extended reality worlds) are system of computer machines connected together via a wired or wireless connection to a network. In some examples, the network may take the form of a local area network (LAN), wide area network (WAN), wired network, wireless network, personal area network, or a combination thereof, and may include the Internet like in the architecture of currently available Metaverses.

As anticipated, in the so-called Metaverse each user controls an anthropomorphic avatar.

One scenario in the Metaverse may be, during a virtual Seminar coffee break. Attendees may have a drink and may want to do networking. One person, by his/her avatar, may aim to have a talk with new people having an attractive job position or working for a company of particular interest. In such a case the preliminary and very first form of interaction might be, establishing eye contact with the person of interest, in particular, if the user doesn't know him/her. If the last person answers, returning back his/her gaze, i.e. establishing eye contact, then a deeper interaction may start with a talk, exchange of professional particulars and so on.

The same situation might happen when an avatar is walking on a street in the virtual world, and between people around, one person, in particular, attracts his/her attention, instinctively gazing at him/her and hoping in the same back, in order hopefully to start a deeper social interaction.

On the other way round, if one is walking in an area not particularly safe and feels that ill-intentioned avatars are fixating at him/her, in that case, the first avatar might not want to establish eye contact with said ill-intentioned subjects, just to prevent any possible interaction with them. At least this user may establish only very quick preliminary eye contact, just to find confirmation that these ill-intentioned avatars are fixating right on him/her, and then interrupting any further eye contact with them.

Because of technical problems in the consumer market, currently, common VR headsets for the consumer market are not provided with eye tracking module, being able to detect the gaze direction of the user and therefore replicating that on the correspondent Avatar in the virtual world, therefore this kind of social interactions are simply technically solved imposing to the user to click with a device (mouse, pad or others) or to point with the device to the other avatar, to request a specific connection, knowing his/her particular if it's possible and so on.

The present invention aims to solve technical problems by implementing a method based on eye contact which is able to trigger automatic action/status change on avatars, in order to improve social interaction between users acting in the Metaverse or in virtual worlds. In the Metaverse and virtual worlds every object, including avatars is positioned according to the Metaverse world coordinates and the Metaverse simulation engine controls the state of the virtual environment and has global knowledge about the position of the objects in the Metaverse.

It's also known that an Avatar is represented as a 3D-mesh, i.e. it's a mathematical model of an anthropomorphic being, with known position of the avatar s face and its eyes, nose, mouth for instance and every part of its body in general.

Each avatar has a virtual camera with known parameters (e.g., focal length) to render the view of the Metaverse 3-D scene from the avatar's perspective and Avatar's virtual camera is attached to the avatar's gaze vector and changes its position and orientation in the Metaverse world coordinates.

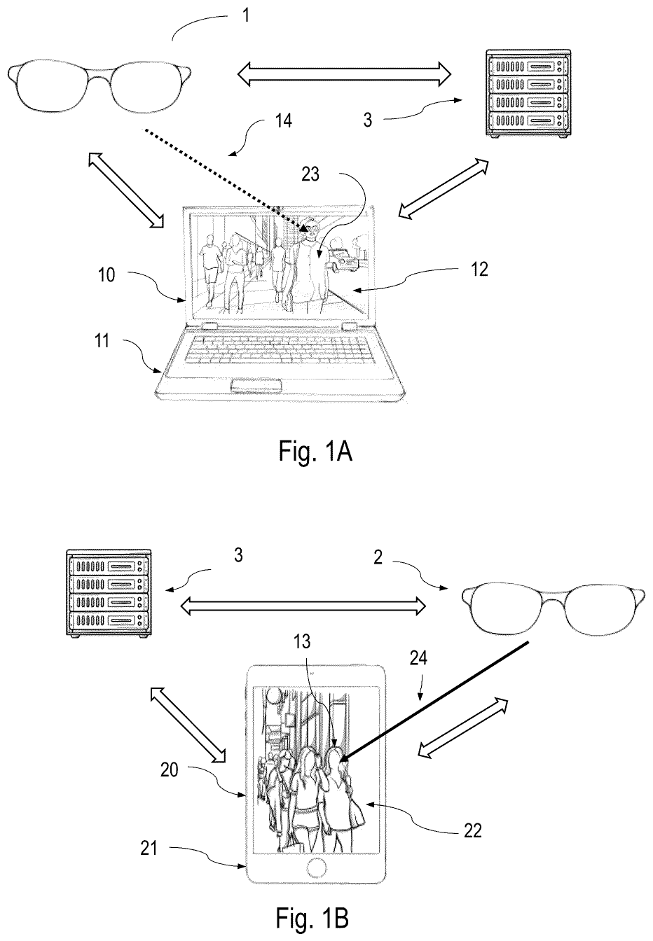

The present invention deals in particular with two system architecture scenarios corresponding to two different systems of devices. A first scenario wherein system comprises at least a first and a second user wearing their correspondent first and second wearable device 1, 2, in this case, gaze tracking device i.e. gaze tracking glasses or smart glasses in general, provided with eye tracking module and a front camera, such technology being able to detect the gaze direction of each first and second user (FIG. 1a, 1b). The system further comprises a first and a second display 10, 20 being part of a correspondent first and second computer devices 11, 21, said first and second display 10, 20 being visible by the first and the second user wearing their gaze tracking glasses/smart glasses, and one or more servers 3 providing the virtual scene 12, 22 of the virtual world being shown on the first and second display 10, 20, according to the respective virtual scenes 12, 22 of the first and second users. The bidirectional outlined arrows, in FIGS. 1a and 1b, indicate the bidirectional communication between the first and second computer devices 11, 21 and server 3, and first and second wearable devices 1, 2.

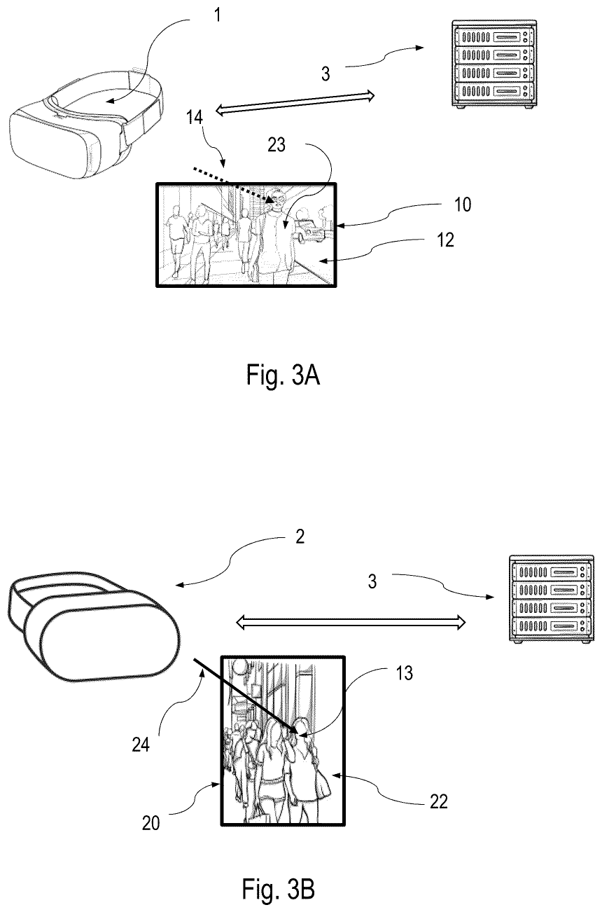

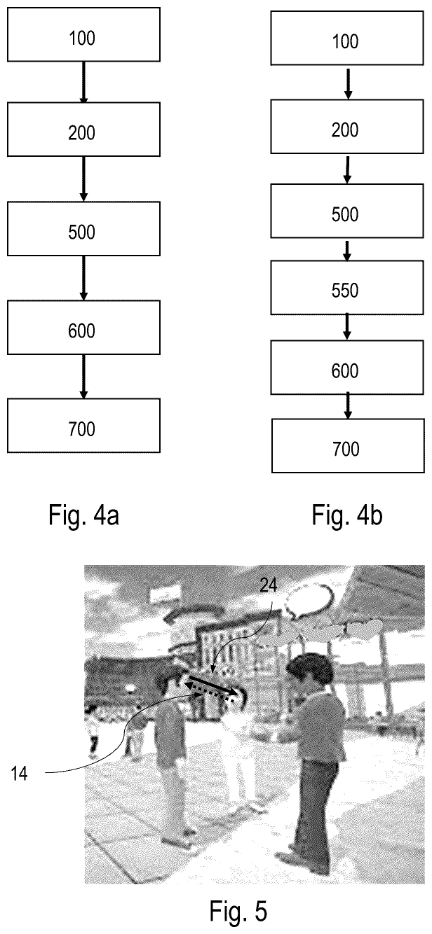

A second scenario (FIG. 3a, 3b) wherein the system comprises first and second wearable devices 1, 2, namely first and second VR headsets 1, 2 provided with an eye-tracking module being able to detect where the user is looking on the displays of the VR headset, being worn by the first and second user respectively, such technology being able to detect the gaze direction of each first and second user. The first and second VR headsets 1, 2 further comprise a first and a second display 10, 20, being integrated into the VR headsets and being visible by the first and the second user wearing their VR headsets, said first and second VR headsets 1, 2 connectable via Internet or to a local LAN to one or more servers 3 providing the virtual world being shown on the first and second display, according to the respective virtual scenes 12, 22 of the first and second users. The bidirectional outlined arrows, in FIGS. 3a and 3b, indicate the bidirectional communication between server 3 and first and second wearable devices 1, 2.

The gaze tracking device 1 may have a frame, wherein the frame has at least one receiving opening/lens receptacle opening for a disk-like structure, and wherein the frame has a U-shaped portion where are preferably located a right eye acquisition sensor and a left eye acquisition sensor, said sensors having the purpose of detecting the position of the user's eye, in order to determine continuously his gaze direction when in use.

The frame may have a U-shaped portion provided for arranging the gaze tracking device 1 on the nose of a human.

A third mixed scenario deals with a system where the first user wears a gaze-tracking device and the second user wears a VR headset or vice versa. In this case, the gaze tracking device will use the method according to the first scenario, while the VR headset device will use the method according to the second scenario described in this specification. The specifications “right” or “left” or “high” or “low” relate to the intended manner of wearing the gaze tracking device 1 by a human being.

As mentioned before, in a preferred solution, the right eye acquisition sensor is arranged in the right nose frame part, and the left eye acquisition sensor is arranged in the left nose frame part of the gaze tracking device. The two eye acquisition sensors may be designed as digital cameras and may have an objective lens. In a preferred solution, the two eye acquisition cameras are each provided to observe one eye of the human wearing the relevant gaze tracking device 1 and to prepare in each case an eye video including individual eye images or individual images.

According to one preferred embodiment of gaze tracking device 1, it is provided that at least one field of view camera is arranged on the gaze tracking device frame, preferably in the U-shaped portion of the frame. The field of view camera is provided to record a field of view video, including an individual and successive field of view images. The recordings of the two eye acquisition cameras and the at least one field of vision camera can thus be entered in correlation in the field of vision video of the respective gaze point.

A larger number of field of view cameras can also be arranged in the gaze tracking device 1.

In order to perform the method according to the present invention it may be used a gaze tracking module, not having the shape of a pair of eyeglasses, comprising at least two eye sensors (one for each eye) and a field of view camera as already explained, therefore in any kind of gaze-tracking device.

It is preferably provided that the gaze tracking device 1 has electronical components like a data processing unit and a data interface, the data processing unit may be connected to the right eye acquisition sensor and the left eye acquisition sensor. The gaze tracking device 1 furthermore may have an energy accumulator for the energy supply of the right eye acquisition sensor and the left eye acquisition sensor, as also the data processing unit and the data interface.

According to one particularly preferred embodiment of present gaze tracking device 1 it is provided that the electronic components, including a processor and a connected storage medium, may be arranged in the sideway part of the frame of the gaze tracking device. The entire recording, initial analysis, and storage of the recorded videos can thus be performed in or by the gaze tracking device 1 itself or by a computer device 2 connected to the gaze tracking device 1.

A data processing unit also comprises a data memory. It is preferably designed as a combination of a microcontroller or processor together with RAM. The data processing unit is connected in a signal-conducting manner to a data interface. It can also be provided that the data interface and the data processing unit are formed jointly in hardware, for example, by an ASIC or an FPGA. The interface is preferably designed as a wireless interface, for example, according to the Bluetooth standard or IEEE 802.x, or as a wired interface, for example, according to the USB standard, wherein in this case the gaze tracking device 1 has a corresponding socket, for example, according to micro-USB. Additional sensors could be inserted in the gaze tracking device 1 and connected with the data processing unit. The data processing unit and the data interface may be connected at least indirectly to the energy accumulator by circuitry, and are connected in a signal-conducting manner to the field of view camera, the right eye acquisition sensor, and the left eye acquisition sensor.

The gaze vector in the real world may be also obtained using Stationary eye-tracking: a stationary mounted device with a known fixed position related to a display (in this case the so-called first and second display of a computer display device, which provides the gaze vector of a user relative to the head frame.

As already described, the present described method is particularly well-suitable for gaze tracking glasses according to the first scenario already described.

On the other hand, in the second scenario, a VR headset is a head-mounted device, such as goggles. It comprises at least a stereoscopic head-mounted display, being able to provide separate images for each eye, stereo sound, and tracking sensors for detecting head movements. The VR headset is strapped onto the user's head over the eyes, such that the user is visually immersed in the content they are viewing.

The user viewing the content can use gaze for the gesture to select and browse through the 3D content or can use hand controllers such as gloves. The controllers and gaze control help track the movement of the user's body and place the simulated images and videos in the display appropriately such that there is a change in perception.

A VR headset may also comprise other optional devices such as audio headphones, cameras, and sensors to track user movements and feed it to a computer or phone, and wired or wireless connections. These are used to improve user experience.

The first scenario is more complex than the second one, because it deals with many reference system transformations in order to place the user's gaze vector in the virtual world, i.e. real-world coordinate system, gaze-tracking coordinate system (head frame), display coordinate system (XY-plane) which is the display device visible by the user, Metaverse virtual camera coordinate system, Avatar head frame coordinate system, Metaverse world coordinate system. Particular attention shall be taken when it deals with the display coordinate system. The display is assumed to be a rectangular display with known width and height, with the X and Y axes of the display coordinate system being aligned with the edges of the display and the Z-axis being positioned in a way that X, Y, and Z axes form left-handed coordinate system and with Position of a display in the world coordinates is identified by the position of the image plane (XY-plane) and its orientation in world coordinates.

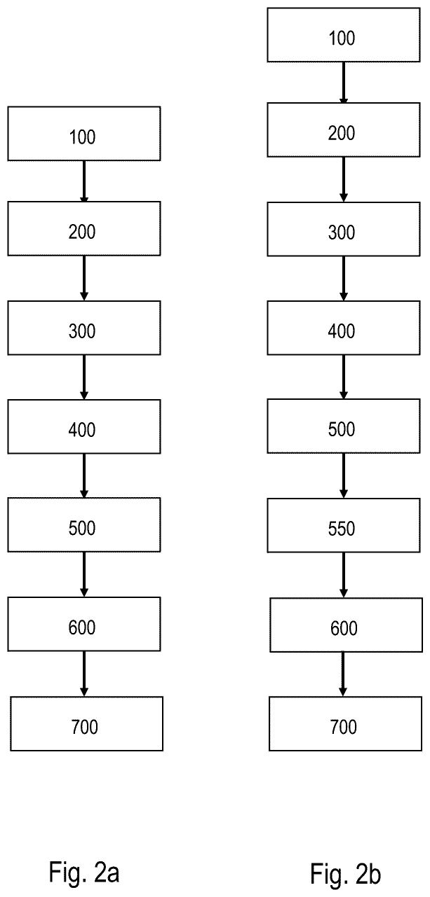

In the first and second scenarios the method for triggering an action in the Metaverse or virtual world which may be provided by a computer server 3 according to the present invention comprises the following core steps, assuming that avatars have an anthropomorphic shape (see FIG. 2a):
100—having a first avatar 13 and a second avatar 23 in the same virtual environment in the Metaverse or in a virtual world, said first and second avatar 13, 23 being able to see each other in a such virtual environment by their correspondent virtual cameras and causing rendering a virtual scene 12 according to the first avatar virtual camera on a first display 10 visible by the first user, said virtual scene 12 including the second avatar 23, and causing rendering a virtual scene 22 according to the second avatar virtual camera on a second display 20 visible by a second user, said virtual scene 22 including the first avatar 13;
(this step is implemented by Metaverse simulation engine which 15 renders the 3D scene from a virtual camera of an avatar on the corresponding user's display);
200—receiving first gaze vector 14 data of the first user by a first gaze tracking device 1 and second gaze vector 24 data of the second user by a second gaze tracking device 2;
500—mapping in the Metaverse or in the virtual world the coordinates of the first gaze vector 14 onto the first avatar 13 and the second gaze vector 24 onto the second avatar 23,
550 moving eyes of the first and the second avatar 13, 23, according to the data of the first and second gaze vectors 14, 24 respectively in the virtual environment; this step is optional, (see FIG. 2b, 4b) and may be implemented in both system architecture scenarios and in all the embodiments of the present invention,
600—in the Metaverse or in the virtual world, having a predetermined first region of interest 612 defined on the first avatar face and a second region of interest 622 defined on the second avatar face;
700—if the first gaze vector 14 is pointing to the second region of interest 622 on the second avatar face and concurrently if the second gaze vector 24 is pointing to the first region of interest 612 on the first avatar face, then triggering an action on the first avatar 13 and on the second avatar 23.

Regarding step 200 it shall be highlighted that it may be performed by a portable gaze-tracking, already described in this specification and by a stationary gaze-tracking system, which generally is designed comprising a stereo camera mounted in a fixed known position relative to the display, said camera being able to identify face, eyes, and pupils of the user using image recognition techniques, computing, in turn, the gaze vector by the stereo data obtained from the camera.

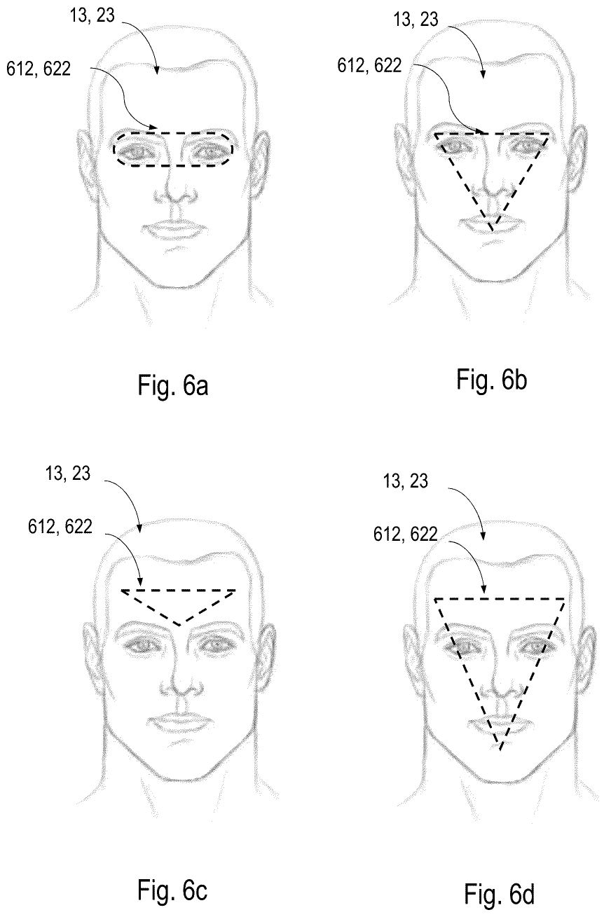

The region of interest 612, 622 mentioned in step 600 preferably comprises the eyes of the avatar 13, 23 therefore any region of interest fulfilling this requirement is a good candidate for the method according to the present invention. Preferably, the region of interest 612, 622 may be designed as convex hull which may be the smallest convex region that contains both eyes (see FIG. 6a) of the avatar mesh/model said match between the eye vector and correspondent designed region of interest 612, 622 on the other avatar meaning willingness of establishing social interaction between the two users, acting by their avatars. The region of interest 612, 622 may be defined by social triangle that is an imaginary inverted isosceles triangle on the avatar's face around including its eyes and ending with the vertex common to the triangle equal sides on the center of the mouth (see FIG. 6b) or of the chin, said match between the eye vector and said designed region of interest meaning not only willingness of establishing social interaction but also emotional involvement towards the other avatar. Furthermore the region of interest 612, 622 may be designed as an inverted imaginary isosceles triangle with the basis on the middle of the forehead, ending with the vertex common to the triangle equal sides on the lowest point of the nose (see FIG. 6d) or on the middle between the eyebrows (see FIG. 6c) of the avatar the user is looking at, said match between the eye vector and said designed region of interest 612, 622 meaning willingness of establishing business and/or formal interaction, the last in case of insecure/suspicious willingness of interaction.

As already mentioned, the region of interest 612, 622 in the Metaverse or virtual world may be defined very precisely, being the coordinates of the entire anthropomorphic shape of the avatar known, therefore in view of the option chosen between convex hull/social triangle/formal triangle, all said region of interest 612, 622 may be univocally defined by choosing specific points in each model avatar.

It may be further defined as a boundary area around the region of interest 612, 622, to increase the possibility of having eye contact and to compensate any possible misalignment or mismatch related to different deepen of points in the region of interest 612, 622, being the last a 3D surface.

A further preferred embodiment of the method according to the present invention, deals with solving the problem of how to make a first avatar 13, and consequently, its user, feel that another avatar, namely a second avatar 23 is looking at the first one and wants to interact with it, consequently with the correspondent user. It may happen in fact that an important opportunity to interact may be missed without knowing that it is present. This problem may be solved by the following step:
if the second gaze vector 24 is pointing to the first region of interest 612 on the first avatar face, then triggering a stimulating action on the first avatar 13.

The step mentioned above may be implemented in every embodiment disclosed in the present specification and obviously, the first avatar 13 and second avatar 23 roles may be interchanged, being consistent with the wording of the correspondent method step.

This feature aims to make sensually recognizable for the avatar 13, 23 and consequently for the correspondent user that he/she is observed by someone else. The stimulating action may be one of the followings: showing on the first display 10 a special symbol/sign, a specific status change or everything that may make the first user clearly feel the second avatar 23 acted via the second user, is looking at its first avatar 13.

In addition, it may be implemented that in order to trigger an advanced interaction action, the eye contact between the two avatars 13, 23, shall be required two times when the steps 650 and 850 are implemented, thus the following step, may be added to all the embodiments disclosed in the present invention:
if the first gaze vector 14 is pointing to the second region of interest 622 on the second avatar face and concurrently if the second gaze vector 24 is pointing to the first region of interest 612 on the first avatar face, namely being established a first eye contact, and if afterwards a second eye contact is again established between the two avatars 13, 23, then an advanced interaction action is triggered on the first avatar 13 and on the second avatar 23.

This technical feature aims to implement a safer and more robust procedure to detect a real and unambiguous intention of social interaction (advanced interaction action) between two users, via their avatars.

To take into consideration the relative position of the gaze tracking device 1, 2—so-called gaze tracking system pose-relative to the display 10, 20 of the computer device 11, 21 in the first scenario the method further comprises:
determining the pose relative to the real world coordinate system of the first and second wearable devices 1, 2, the lasts being gaze tracking devices 1, 2; the gaze tracking system pose is intended as the position and orientation of the gaze tracking system in the world coordinates.

In order to determine the pose of the gaze tracking devices 1, 2 must be known in the real-world coordinate system. There are several options for obtaining the gaze tracking device's pose.

One first option is using gaze tracking glasses front camera to get the pose of the gaze tracking glasses relative to the display. This can be achieved by displaying a particular marker (Aruco marker, for instance) on (or near) the display and using image recognition technique to get the pose of the marker. With this information, the eye gaze can be mapped onto the coordinate system of the display. To achieve the same goal, also image recognition technique itself may be used, which is able according to specific algorithms to detect the pose of the display relative to the camera frame.

One second example is using stationary eye tracker to get eye gaze vectors. The stationary tracker is attached to a known position relative to the display. Because of the poses of the eyes and the pose of the eye tracker are known (in relation to the display), detected gaze vectors can be mapped to the display coordinate system using transformation matrices.

A further problem to be solved is how to take into consideration eye parallax compensation. Eye parallax can be compensated using offset data between the vertical position of the front camera of the gaze tracking device 1, 2 and the user's eyes and knowing the distance between the gaze tracking glasses 1, 2 and the display 10, 20. Said distance will be known from the gaze tracking glasses pose obtained with one of the above-described methods.

Therefore the relevant step is:
calculating the distance between the gaze tracking glasses 1, 2 and the correspondent display 10, 20 and then calculating the parallax compensation.

In addition, the following step is related to the first scenario:
transforming the first and second gaze vectors 14, 24 of the first and second users determined by the first and second wearable devices 1, 2, the last being gaze tracking devices 1, 2, in the coordinate system of the first and second display 10, 20 of the first and second computer device 11, 21 (by applying extrinsic matrix to perform coordinate transformation).

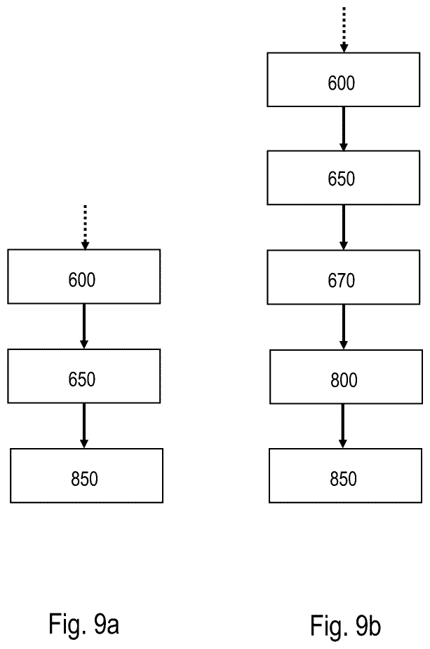

In both first and second scenarios and generally to all the embodiments of the present invention, it may be implemented also further steps aiming to defining the eye contact time, in order to prevent that the eye contact may be exchanged as staring phenomenon, thus being able to recognize a real interest in actively social interacting. The corresponding steps are the following (see FIG. 9a):
determining the eye contact time, namely the time during which the gaze vectors 14, 24 are concurrently pointing to the correspondent region of interest 612, 622 according to step 600 and having a predetermined glance-avoidance time, corresponding to preventing any social interaction.
if the first gaze vector 14 is pointing to the second region of interest 622 on the second avatar face and concurrently if the second gaze vector 24 is pointing to the first region of interest 612 on the first avatar face, and if the eye contact time matches the predetermined glance-avoidance time, then triggering an avoidance action on the first avatar 13 and on the second avatar 23.

In the present invention a preferred solution is defining the glance avoidance time event criterion occurring when gaze vectors 14, 24 are stabilized over the correspondent region of interest 612, 622 according to step 600, matching it, for a predetermined period of eye contact time, preferably in the range 0.5 to 2 sec, more precisely 0.5≤t<2 seconds. Furthermore, a preferred solution is defining the social interaction time event criterion occurring when gaze vectors 14, 24 are stabilized over the correspondent region of interest 612, 622 according to step 600, matching it, for a predetermined period of eye contact time preferably in the range 2 to 4 seconds, more precisely 2≤t≤4 seconds.

The method described in the present invention may further be implemented on display of smartphones or any kind of computer device provided with a screen, in particular touchscreen.

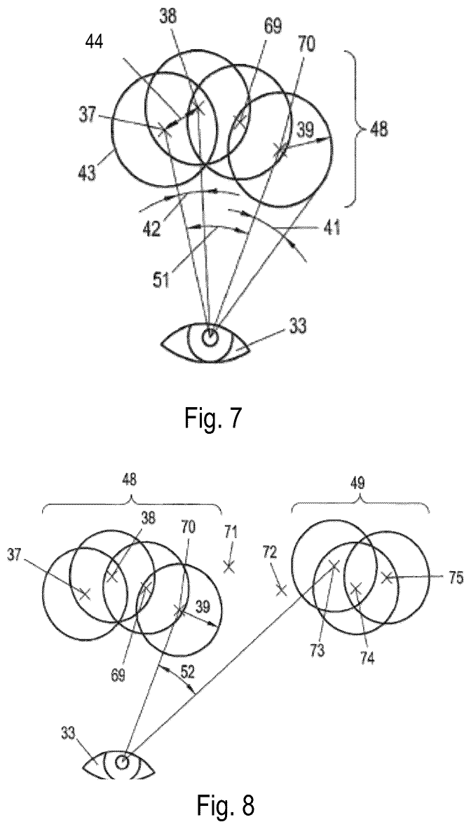

The method in the present invention involves an important well-known fixation concept which can be used to set up the gaze time. One definition of this concept is easily understandable according to FIGS. 7 and 8 and the following paragraphs.

According to FIGS. 7 and 8, directly following example points of vision 37, 38 are at least tested and compared in a comparison device in relation to compliance with at least the first fixation criterion 25. The comparison device can be any suitable device. Particular preference is given to devices that use this type of electronic logic module in integrated form, particularly in the form of processors, microprocessors and/or programmable logic controllers. Particular preference is given to comparison devices that are implemented in a computer.

The comparison device processes so-called visual coordinates, which 25 can be abbreviated in the following as VCO, and which can be determined based on a correlation function described above between a visual field image 79 and an eye image 78, wherein other methods or procedures can be used to determine these VCO.

The first fixation criterion 25 can be any type of criterion, which allows a differentiation between fixations and saccades. The preferred embodiment of the method according to the invention provides that the first fixation criterion 25 is a predefinable first distance 39 around the first point of vision 37, that the first relative distance 44 between the first point of vision 37 and the second point of vision 38 is determined, and that if the first relative distance 44 is less than the first distance 39, the first and second points of vision 37, 38 are assigned to the first fixation 48, therefore as long as a second point of vision 38 following a first point of vision 37 remains within the foveal area 34 of the first point of vision 37 and thus within the area of ordered perception of the first point of vision 37, ordered perception is not interrupted and thus continues to fulfil the first fixation criterion 25. This is therefore a first fixation 48. A particularly preferred embodiment of the method according to the invention provides that the first distance 39 is a first viewing angle 41, which preferably describes an area 34 assigned to foveal vision, in particular a radius between 0.5° and 1.5°, preferably approximately 1°, and that the distance between the first point of vision 37 and the second point of vision 38 is a first relative angle 42. Based on the visual coordinates determined using a gaze tracking system, it is possible to determine saccades and fixations 48, 49 simply and accurately. FIG. 7 shows a first fixation 48, for example, which is formed from a sequence of four points of vision 37, 38, 69, 70. FIG. 7 also shows the first distance 39, the first viewing angle 41, the first relative distance 44 and the first relative angle 42. Around each of the four points of vision 37, 38, 69, 70 is a first circle 43 with the radius of the first distance 39, wherein it is clearly shown that the following point of vision 38, 69, 70 lies within the first circle 43 with radius first distance 39 of the preceding point of vision 37, 38, 69, and thus the preferred first fixation criteria 25 is met. In order to adapt to objects that are perceived differently or to different people and/or conditions, a further updated version of the invention provides that the first fixation criterion 25, particularly the first distance 39 and/or the first viewing angle 41, can be predefined.

FIG. 8 shows a viewing sequence in which not all points of vision 37, 38, 69, 70, 71, 72, 73, 74, 75 satisfy the first fixation criterion 25. The first four points of vision (37, 38, 69, 70 satisfy the fixation criterion 25 and together form the first fixation 48, wherein the following three points of vision 71, 72, 73 do not satisfy the first fixation criterion 25. Only the fourth point of vision 74 following the first fixation 28 satisfies the first fixation criterion 25 compared to the third point of vision 73 following the first fixation 48. The third point of vision 73 following the first fixation 48 is therefore the first point of vision 73 of the second fixation 49, which is formed from a total of three points of vision 73, 74, 75. FIGS. 7 and 8 show illustrative examples, although fixations 48, 49 can occur in natural surroundings with a variety of individual points of vision. The area between the last point of vision 70 of the first fixation 48 and the first point of vision 73 of the second fixation 49 forms a saccade, therefore an area without perception. The angle between the last point of vision 70 of the first fixation 48 and the first point of vision 73 of the second fixation 49 is referred to as the first saccade angle 52.

The points of vision 37, 38 assigned to a saccade or a fixation 48, 49 can now be output for further evaluation, processing or representation. In particular, it can be provided that the first and the second point of vision 37, 38 can be output and marked as the first fixation 48 or the first saccade.

The following ones are further fixation and saccade definitions that may be used and implemented in the method to mark a fixation event according to the present invention:
Saccades are rapid movements of the eyes with velocities as high as 500° per second, while in fixations eyes remain relatively still during fixations for about 200-300 ms; (5)
Fixations are eye movements that stabilize the retina over a stationary object of interest, while Saccades are rapid eye movements used in repositioning the fovea to a new location in the visual environment; (5)
Using distinction between the periods in which an area of the visual scene is kept on the fovea—a fixation—and periods in which an area of the visual scene is brought onto the fovea—a rapid eye position change called a saccade; (5)
Defining a saccade when the visual point direction of the gaze tracking device wearer has moved more than a certain angle per time, (i.e. if it has more than a minimal angular velocity). The cutoff criterion in this 31 case may be specified in units of angular velocity.

The method according to the present invention may trigger different kinds of actions, avoidance actions, interaction actions, and advanced interaction actions. Actions may be an avatar status change or triggering some facial gestures on the avatar itself or highlighting the nickname of the avatar, setting cookies acceptance, giving consensus to certain privacy settings and so on.

Interaction action may consist of opening a chat box between the two avatars, therefore allowing the users, by their avatars, to chat and exchange preliminary information, starting a first form of interaction or showing the real name or Country where the user is located.

Advanced interaction actions may be allowing access to other channels of communication between the users, via audio messages, via video contents, if the gaze tracking devices 1, 2 and the VR headset are provided with speakers and microphone, or automatically switching on such devices, allowing the exchange of audio data in the system, thus allowing, in turn, the user speaking and listening to each other. Another action which may be triggered is allowing “physical contact” between avatars in the Metaverse or virtual worlds, like for example hand shaking or hugging, or it may be an automatic change of privacy setting of a specific avatar, thus meaning that after eye contact has been established, automatically it may be shown full particulars of the user commanding the other avatar, or even certain set up related to availability to receive commercial offers or advertisement or technical cookies.

On the contrary, avoidance actions may be blocking any further possible eye contact with the other avatar or even blocking any further possibility to be “physically” close to the other avatar in the Metaverse or virtual world.

The present invention relates furthermore to VR headset 1, 2, a computer device 11, 21, a server 3 comprising a processor, a computer-readable storage medium coupled to the processor said computer-readable storage medium having stored thereon computer-executable instructions which, when executed, configure the processor to perform the corresponding steps of the method already described in the present specification.

The present invention relates furthermore to a gaze-tracking device 1, 2, comprising a processor, a computer-readable storage medium coupled to the processor said computer-readable storage medium having stored thereon computer-executable instructions which, when executed, configure the processor to perform some corresponding steps of the method already described in the present specification, in particular, the following steps:
being able to see a first avatar 13 and a second avatar 23 in the 20 same virtual environment in the Metaverse or in a virtual world, said first and second avatar 13, 23 being able to see each other in such virtual environment by their correspondent virtual cameras and causing rendering a virtual scene 12 according to the first avatar virtual camera on a first display 10 visible by the first user, said virtual 25 scene 12 including the second avatar 23, and causing rendering a virtual scene 22 according to the second avatar virtual camera on a second display 20 visible by a second user, said virtual scene 22 including the first avatar 13;
providing first gaze vector 14 data of the first user by a first gaze tracking device 1 and second gaze vector 24 data of the second user by a second gaze tracking device 2;
causing mapping in the Metaverse or in the virtual world the coordinates of the first gaze vector 14 onto the first avatar 13 and the second gaze vector 24 onto the second avatar 23,
causing identifying a predetermined first region of interest 612 defined on the first avatar face and a second region of interest 622 defined on the second avatar face in the virtual environment;
if the first gaze vector 14 is pointing to the second region of interest 622 on the second avatar face and concurrently if the second gaze vector 24 is pointing to the first region of interest 612 on the first avatar face, then causing triggering an action on the first avatar 13 and on the second avatar 23.

The gaze tracking device 1, 2 defined above may further implement a method according to all the different technical features and embodiments described in the present specification.

An object of the present invention is also the computer readable storage medium having stored thereon computer executable instructions which, when executed, configure the processor to perform the corresponding steps of the method already described in the present specification, according to all the embodiments described and disclosed in this specification.

An object of the present invention is also a system for triggering status change and/or specific action between two avatars acting in the Metaverse or in a virtual world, said virtual world which may be a virtual/mixed/extended reality world, the system includes at least a first and a second wearable devices 1, 2, a processing unit able to process the gaze tracking data of the wearable devices 1, 2 and a computing system connectable with the processing unit and configured to host the virtual world being shown on the first and second display, according to the respective virtual scenes 12, 22 of the first and second users. The computing system may be the server device 3, including the processing unit or may include more servers or computer devices. The computing system may be implemented as/operate as or include a server for hosting the virtual world.

A system of and/or including one or more computers can be configured to perform particular operations or processes by virtue of software, firmware, hardware, or any combination thereof installed on the one or more computers that in operation may cause the system to perform the processes. One or more computer programs can be configured to perform particular operations or processes by virtue of including instructions that, when executed by a one or more processors of the system, cause the system to perform the processes.

Other embodiments include corresponding computer systems, computer-readable storage media or devices, and computer programs recorded on one or more computer-readable storage media or computer storage devices, each configured to perform the processes of the methods described herein.

In a preferred embodiment the computing system is connected with a processing unit connectable with or even forming a part of the wearable devices 1, 2.

The processing unit may be operable as a client when connected with the computing system operating as server.

Client(s) and server are typically remote from each other and typically 10 interact through a communication network such as a TCP/IP data network. The client-server relationship arises by virtue of software running on the respective devices.

Furthermore, the system is typically also configured to execute any of the processes explained in the present specification.

In a preferred embodiment the system comprises
a first and second wearable devices 1, 2 as described in the present specification,
at least one processing unit configured to carry out the steps of the method in the present specification in all the preferred embodiments described.

Furthermore, said system, wherein the processing unit is provided by a desktop computer or a server, or wherein the processing unit is integrated into the wearable devices 1, 2 described in all the embodiments according to the present specification.

### REFERENCES

(1) Sang-Min Park, et al. (2022). A Metaverse: Taxonomy, Components, Applications, and Open Challenges.
(2) M. Kaur, et al. (2021). Metaverse Technology and the current Market.
(3) Justin Goldston et al. (2022). The Metaverse as Digital Leviathan: a case study of Bit. Country:
(4) smita.verma (2022). Metaverse Vs. Virtual Reality: a detailed comparison. https://www.blockchain-council.org/Metaverse/Metaverse-vs-virtual-reality/
(5) Roy S. Hessels (2017). Noise-robust fixation detection in eye movement data: Identification by two-means clustering (I2MC)

1-15. (canceled)

16. A method for triggering an action in a Metaverse or in a virtual world, wherein a first user, wearing a first wearable device, and a second user, wearing a second wearable device, act via their avatars, said avatars having an anthropomorphic shape, comprising:
providing a first avatar and a second avatar in a same virtual environment in the Metaverse or in the virtual world, said first and second avatar being able to see each other in such virtual environment by their correspondent virtual cameras and causing rendering a virtual scene according to the first avatar virtual camera on a first display visible by the first user, said virtual scene including the second avatar, and causing rendering a virtual scene according to the second avatar virtual camera on a second display visible by a second user, said virtual scene including the first avatar;
receiving first gaze vector data of the first user by a first gaze tracking device and second gaze vector data of the second user by a second gaze tracking device;
mapping in the Metaverse or in the virtual world the coordinates of the first gaze vector onto the first avatar and the second gaze vector onto the second avatar, said first avatar corresponding to the first user and said second avatar corresponding to the second user;
providing a predetermined first region of interest defined on the first avatar face and a second region of interest defined on the second avatar face in the virtual environment; and
if the first gaze vector is pointing to the second region of interest on the second avatar face and concurrently if the second gaze vector is pointing to the first region of interest on the first avatar face, then triggering an action on the first avatar and on the second avatar.

17. The method according to claim 16, wherein the first and second wearable devices are VR headsets including a gaze tracking module.

18. The method according to claim 16, further comprising:
determining a first pose relative to a real world coordinate system of the first wearable device, the first wearable device being the first gaze tracking device;
determining a second pose relative to the real world coordinate system of the second wearable device, the second wearable device being the second gaze tracking device; and
transforming the first gaze vector in a first virtual coordinate system of a first display of a first computer device; and
transforming the second gaze vector in a second virtual coordinate system of a second display of a second computer device.

19. The method according to claim 18, further comprising calculating a distance between the gaze tracking devices and a corresponding display, and then calculating a parallax compensation.

20. The method according to claim 16, further comprising moving eyes of the first and the second avatar according to the data of the first and second gaze vectors respectively.

21. The method according to claim 16, wherein a region of interests is defined in the virtual environment as convex hull including eyes of the avatar or as a social triangle defined as an inverted isosceles triangle on a face of the avatar including the eyes and ending with a vertex common to the triangle equal sides on the center of a mouth of the avatar or as formal triangle defined as an inverted imaginary isosceles triangle with a basis on a middle of the forehead, ending with a vertex common to the triangle equal sides on the lowest point of the nose or on the middle between the eyebrows of the avatar.

22. The method according to claim 16, further comprising:
determining eye contact time, the eye contact time being when the first and second gaze vectors are concurrently pointing to the correspondent first and second region of interest and having a predetermined glance-avoidance time, corresponding to preventing any social interaction; and
if the first gaze vector is pointing to the second region of interest on the second avatar face and concurrently if the second gaze vector is pointing to the first region of interest on the first avatar face, and if the eye contact time matches the predetermined glance-avoidance time, then triggering an avoidance action on the first avatar and on the second avatar.

23. The method according to claim 22, wherein the glance-avoidance time is 0.5 t<2 seconds.

24. The method according to claim 16, further comprising:
determining the eye contact time, being when the first and second gaze vector are concurrently pointing to the correspondent first and second region of interest, and having a predetermined social interaction time, corresponding to real willingness to social interact occurring; and
if the first gaze vector is pointing to the second region of interest on the second avatar face and concurrently if the second gaze vector is pointing to the first region of interest on the first avatar face, and if the eye contact time matches the predetermined social interaction time, then triggering an interaction action on the first avatar and on the second avatar.

25. The method according to claim 24, wherein the predetermined social interaction time is greater than or equal to 2 seconds and less than or equal to 4 seconds.

26. The method according to claim 16, further comprising, if the first gaze vector is pointing to the second region of interest on the second avatar face and concurrently if the second gaze vector is pointing to the first region of interest on the first avatar face, namely being established a first eye contact, and if afterwards a second eye contact is again established between the two avatars, then an advanced interaction action is triggered on the first avatar and on the second avatar.

27. A computer readable storage medium comprising computer-executable instructions which, when executed, configure a processor to perform the method according to claim 16.

28. A server device comprising a processor, a computer readable storage medium coupled to the processor, the computer readable storage medium having stored thereon computer executable instructions which, when executed, configure the processor to perform the corresponding steps of the method according to claim 16.

29. A wearable device comprising a processor, a computer-readable storage medium coupled to the processor, the computer readable storage medium having stored thereon computer executable instructions which, when executed, configure the processor to perform the corresponding steps of the method according to claim 16.

30. A gaze-tracking device comprising a processor, a computer-readable storage medium coupled to the processor said computer-readable storage medium having stored thereon computer executable instructions which, when executed, configure the processor to perform a method for triggering an action in the Metaverse or in a virtual world, wherein a first user, wearing a first wearable device, and a second user, wearing a second wearable device, act via their avatars, said avatars having an anthropomorphic shape, the method comprising:
providing a first avatar and a second avatar in a same virtual environment in the Metaverse or in a virtual world, said first and second avatar being able to see each other in such virtual environment by their correspondent virtual cameras and causing rendering a virtual scene according to the first avatar virtual camera on a first display visible by the first user, said virtual scene including the second avatar, and causing rendering a virtual scene according to the second avatar virtual camera on a second display visible by a second user, said virtual scene including the first avatar;
providing first gaze vector data of the first user by a first gaze tracking device and second gaze vector data of the second user by a second gaze tracking device;
mapping in the Metaverse or in the virtual world the coordinates of the first gaze vector onto the first avatar and the second gaze vector onto the second avatar, said first avatar correspondent to the first user and said second avatar correspondent to the second user;
identifying a predetermined first region of interest defined on the first avatar face and a second region of interest defined on the second avatar face in the virtual environment; and
if the first gaze vector is pointing to the second region of interest on the second avatar face and concurrently if the second gaze vector is pointing to the first region of interest on the first avatar face, then causing triggering an action on the first avatar and on the second avatar.
